(19) United States
(12) Patent Application Publication
(10) Pub. No.: US 2018/0371805 A1
(43) Pub. Date: Dec. 27, 2018

(54) AUTOMOBILE DOOR LOCK DEVICE

(71) Applicant: MITSUI KINZOKU ACT CORPORATION, Yokohama-shi, Kanagawa (JP)

(72) Inventors: Mikio ICHINOSE, Yokohama-shi, Kanagawa (JP); Hiroki HATTORI, Yokohama-shi, Kanagawa (JP)

(73) Assignee: MITSUI KINZOKU ACT CORPORATION, Yokohama-shi, Kanagawa (JP)

(21) Appl. No.: 16/063,215

(22) PCT Filed: Dec. 16, 2015
(86) PCT No.: PCT/JP2015/085241

§ 371 Date: Jun. 15, 2018

(51) Int. Cl. E05B 77/12; E05B 77/26; E05B 81/82; E05B 81/16

(52) U.S. Cl. CPC E05B 77/12; E05B 81/16; E05B 81/82; E05B 77/26

(57) ABSTRACT

A motor vehicle door lock apparatus 1 includes a meshing mechanism configured to mesh with a striker, a locking and unlocking mechanism configured to be switched to an unlocking state where a meshing of the meshing mechanism can be released through an operation of a door handle and a locking state where a meshing of the meshing mechanism cannot be released by a driving of a locking and unlocking motor 13, a child proof locking mechanism 27 configured to be switched to a child proof unlocking state where a meshing of the meshing mechanism can be released through an operation of an inside handle of the door when the meshing mechanism stays in the unlocking state and a child proof locking state where a meshing of the meshing mechanism cannot be released only by a driving of a child proof and double locking motor 35, and a control unit ECU configured, when a collision sensor 46 detects a collision, to control to drive the locking and unlocking motor 13 to activate the unlocking operation and to control to drive the child proof and double locking motor 35 to activate the unlocking operation.

### TECHNICAL FIELD

The present invention relates to a motor vehicle door lock apparatus.

### BACKGROUND ART

In general, a motor vehicle door lock apparatus includes a meshing mechanism configured to mesh with a striker to thereby hold a door in a closed state and a locking and unlocking mechanism configured to be switched selectively to an unlocking state where a meshing of the meshing mechanism can be released and a locking state where a meshing of the meshing mechanism cannot be released. The locking and unlocking mechanism is selectively switched to an unlocking state and a locking state by driving, for example, an actuator. A meshing of the meshing mechanism is released by operating a door handle when the locking and unlocking mechanism stays in the unlocking state, whereby the door is allowed to be opened.

A door lock apparatus is also known that includes further a child proof locking mechanism. The child proof locking mechanism can be switched to a child proof unlocking state where a meshing of a meshing mechanism can be released by operating an inside door handle when a locking and unlocking mechanism stays in an unlocking state and a child proof locking state where a meshing of the meshing mechanism cannot be released. The child proof locking mechanism is switched to the child proof unlocking state and the child proof locking state by driving, for example, a child proof locking actuator (refer to PTL 1).

### CITATION LIST

### Patent Literature

PTL 1: Japanese Patent Publication No. 4923274

### SUMMARY OF INVENTION

### Technical Problem

The locking and unlocking mechanism or the child proof locking mechanism locks the meshing mechanism so that a meshing of the meshing mechanism cannot be released. This can prevent an unexpected opening of the door, whereby an occupant of the vehicle is prevented from being thrown out, for example, while the vehicle is running. On the other hand, at the time of emergency such as a traffic accident, the locked meshing mechanism may interrupt a quick opening of the door for an escape or rescue of the occupant.

In the child proof locking mechanism that is switched to a child proof unlocking state and a child proof locking state by driving the child proof locking actuator, the driving of the actuator is operated by, for example, a remote control switch provided on a driver's seat side or is controlled in association with a gear range or an operation of a foot brake. On the other hand, the child proof locking mechanism is typically provided on the door lock apparatus of a rear side door. This prevents the child proof locking mechanism from being switched to the child proof unlocking state in the case where there is no hope of the driver operating the remote control switch due to the driver being unable to move at the time of emergency such as a collision, leading to fears that it becomes difficult to open the rear side door.

The invention has been made in view of these situations, and an object thereof is to provide a motor vehicle door lock apparatus that includes a child proof locking mechanism and that enables a door to be opened quickly at the time of emergency.

### Solution to Problem

A motor vehicle door lock apparatus according to one illustrative aspect of the invention comprises: a meshing mechanism configured to mesh with a striker to hold a door in a closed state; a locking and unlocking mechanism configured to be switched by a driving of a locking and unlocking motor to: an unlocking state where a meshing of the meshing mechanism can be released through an operation of an outside mechanical operation element provided on a side facing an outside of a motor vehicle or an outer side of the door and an operation of an inside mechanical operation element provided on a side facing an inside of the motor vehicle or an inner side of the door; and a locking state where the meshing of the meshing mechanism cannot be released; a child proof locking mechanism configured to be switched only by a driving of a child proof locking motor to: a child proof unlocking state where the meshing of the meshing mechanism can be released through an operation of the inside mechanical operation element when the meshing mechanism stays in the unlocking state: and a child proof locking state where the meshing of the meshing mechanism cannot be released; and a control unit configured to, after a predetermined length of time elapses since collision detecting means for detecting a collision of the motor vehicle detects the collision, drive the locking and unlocking motor to activate the unlocking operation to switch the locking and unlocking mechanism to the unlocking state, and drive the child proof locking motor to activate the unlocking operation to switch the child proof locking mechanism to the child proof unlocking state.

### Advantageous Effect of Invention

According to the invention, it is possible to provide the motor vehicle door lock apparatus that includes the child proof locking mechanism and that enables the door to be opened quickly at the time of emergency.

### BRIEF DESCRIPTION OF DRAWINGS

FIG. 1 is a side view of a motor vehicle door lock apparatus according to the invention as seen from a side facing an inside of a vehicle or an inner side with a cover removed.

FIG. 2 is a perspective view of the motor vehicle door lock apparatus of the invention as seen obliquely from the front and a side facing an outside of the vehicle or an outer side with a casing removed.

FIG. 3 is a rear view of the motor vehicle door lock apparatus of the invention.

FIG. 4 is an exploded view of a child proof locking mechanism and a double locking lever.

FIG. 5 is a perspective view illustrating a link between a child proof lever and the double locking lever.

FIG. 6 is a side view as seen from the inner side of the vehicle, illustrating a link between the child proof lever and the double locking lever when the child proof lever stays in a first position.

FIG. 7 is also a side view as seen from the inner side of the vehicle, illustrating a link between the child proof lever and the double locking lever when the child proof lever stays in a second position.

FIG. 8 is also a side view as seen from the inner side of the vehicle, illustrating a link between the child proof lever and the double locking lever when the child proof lever stays in a third position.

FIG. 9 is a perspective view illustrating a link between an opening lever and the double locking lever.

FIG. 10 is a side view of a main part of the motor vehicle door lock apparatus as seen from the inner side of the vehicle, when the child proof locking mechanism is in a child proof unlocking state.

FIG. 11 is a side view of the main part of the motor vehicle door lock apparatus as seen from the inner side of the vehicle, when the child proof locking mechanism is put in a child proof locking state.

FIG. 12 is a side view of the main part of the motor vehicle door lock apparatus as seen from the inner side of the vehicle, when the double locking lever is put in a double locking state.

FIG. 13 is a side view of the main part of the motor vehicle door lock apparatus as seen from the outer side of the vehicle, when the double locking lever is put in the double locking state.

FIG. 14 is a side view of a modified example of a linkage device for the child proof lever and the double locking lever as seen from the inner of the vehicle.

FIG. 15 is a block diagram showing a control circuit.

FIG. 16 is a block diagram showing a modified example of a control circuit.

### DESCRIPTION OF EMBODIMENTS

Hereinafter, an embodiment of a motor vehicle door lock apparatus of the invention will be described based on the drawings.

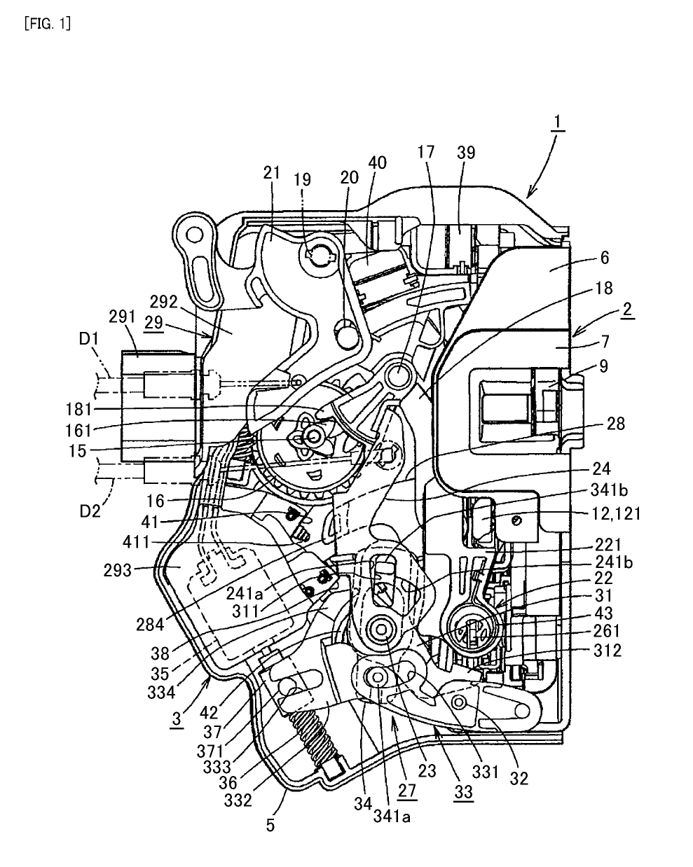

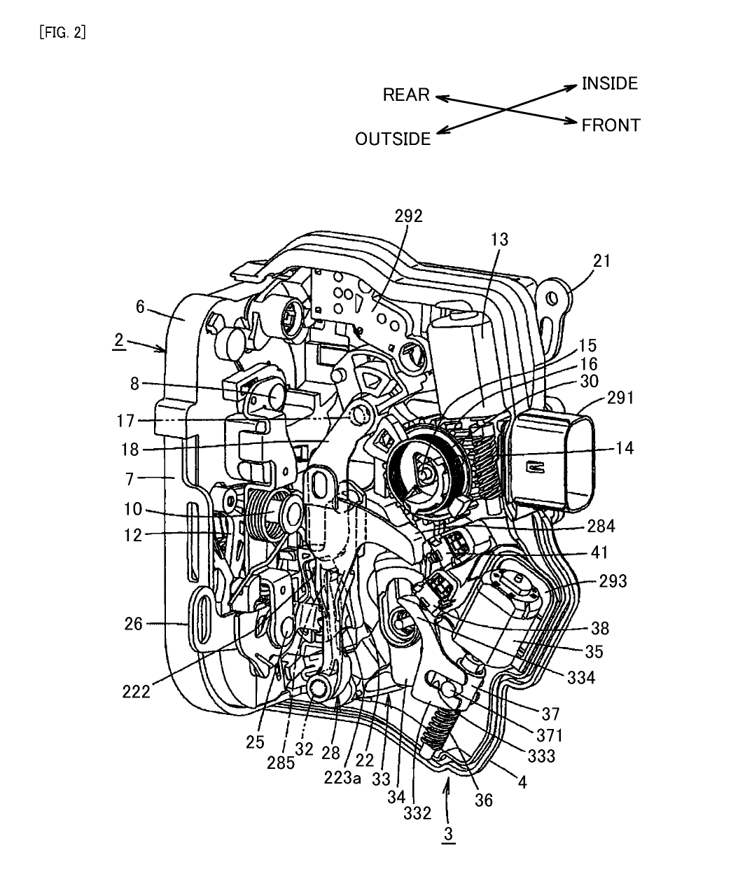

As shown in FIGS. 1 to 3, a motor vehicle door lock apparatus 1 is a door lock apparatus that is provided inside a rear end portion of a rear side door (hereinafter, referred to simply as a door) of a vehicle, not shown, and that includes a double locking mechanism and a child proof locking mechanism. The double locking mechanism is configured to disable an unlocking operation of a lock knob that is provided on a side facing an inside of the vehicle or an inner side. The child proof locking mechanism is configured to disable a door opening operation by an inside handle that is provided on a side facing the inside of the vehicle or an inner side of the rear side door. The door lock apparatus 1 includes a meshing unit 2 configured to hold the door in a closed position and an actuator unit 3 configured to operate a meshing mechanism, which will be described later, of the meshing unit 2. For the sake of clarity of an inside structure of the actuator unit 3, a cover 4, which covers a lateral surface on a side facing the inside of the vehicle or an inner side of the actuator unit 3, is omitted in FIG. 1, and a casing 5, which covers a lateral surface on a side facing an outside of the vehicle or an outer side of the actuator unit 3 and a front surface of the meshing unit 2, is omitted in FIG. 2.

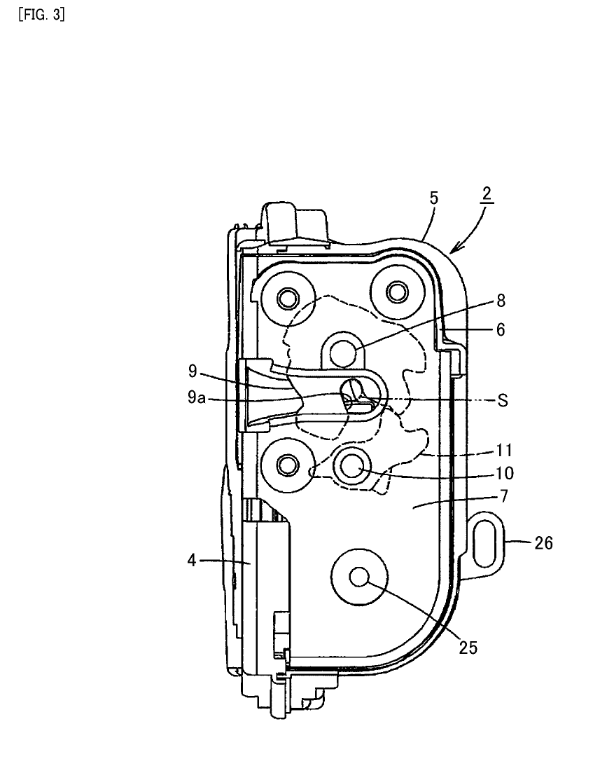

As shown in FIG. 3, the meshing unit 2 includes: a box-shaped body 6 that is opened on a rear surface and is made from a synthetic resin; a metallic cover plate 7 that is fixed to a rear surface of the body 6 and is then fixed to an inner surface of a rear end portion of an inner panel of the door together with the body 6 with a plurality of bolts (omitted from illustration); a latch 9 accommodated in an inside space defined between the body 6 and the cover plate 7 while being supported on a latch shaft 8 that extends in a front and rear direction and having an engaging groove 9a with which a striker S on a vehicle body side can be brought into engagement; a ratchet 11 accommodated in the inside space defined between the body 6 and the cover plate 7 while being supported on a ratchet shaft 10 that extends in the front and rear direction and configured to prevent a rotation of the latch 9 in an opening direction (a direction in which an engagement thereof with the striker S is released) by being brought into engagement with the latch 9; and an opening lever 12 (refer to FIGS. 1, 2) that is secured to the ratchet shaft 10 on a front surface side of the body 6 and configured to rotate together with the ratchet 11. The latch 9 and the ratchet 11 correspond to the meshing mechanism of the invention.

The actuator unit 3 includes: the casing 5 that is fixed to the body 6 of the meshing unit 2 and is made from a synthetic resin; a locking and unlocking motor 13 that is accommodated in a front upper portion inside the casing 5 with its rotational shaft directed obliquely downwards to the front and is configured to rotate forwards and backwards based on an operation of a remote control switch or the like (omitted from illustration); a worm 14 that is secured to the rotational shaft of the locking and unlocking motor 13 that is directed downwards; a worm wheel 16 that meshes with the worm 14 and that is supported rotatably inside the casing 5 by a shaft 15 that is directed in an inside and outside direction of the vehicle; a locking and unlocking lever 18 that is supported rotatably inside the casing 5 by a shaft 17 that is directed in the inside and outside direction of the vehicle and that can rotate to an unlocking position where an opening operation of the door is made possible and a locking position where the opening operation of the door is made impossible; a knob lever 21 that is supported rotatably on a shaft 19 that is provided at an upper portion of the cover 4 so as to be directed towards the outside of the vehicle, is coupled to a lock knob (omitted from illustration) for manual operation that is provided on the inner side of the door by means of an operation force transmitting member D1 such as a Bowden cable or the like, and is coupled to a pin 20 that is provided at an upper end portion of the locking and unlocking lever 18 so as to be directed towards the inside of the vehicle at a lower portion thereof; an opening link 22 that is linked with the locking and unlocking lever 18 so as to rotate to an unlocking position and a locking position; an inside lever 24 in which a lower end portion is supported rotatably on a shat 23 that is provided on the casing 5 so as to be directed in the inside and outside direction of the vehicle in an upper position lying nearer to a child proof lever 33, which will be described later, and an upper end portion is coupled to an inside handle (omitted from illustration) provided on the inner side of the door and functioning as an inside mechanical operation element for opening the door by means of an operation force transmitting member D2 such as a Bowden cable or the like; an outside lever 26 that is supported rotatably on the body 6 via a shaft 25 directed in the front and rear direction and is coupled to an outside handle (omitted from illustration) provided on the outer side of the door and functioning as an outside mechanical operation element by a rod or the like, not shown; a child proof locking mechanism 27 configured to be switched to a child proof unlocking state where a door opening operation by the inside handle can be transmitted to the opening link 22 and the ratchet 11 of the meshing unit 2 via the inside lever 24 and a child proof locking state where the transmission of the operation force is made impossible; a double locking lever 28 that is linked with the opening link 22 and the child proof locking mechanism 27 and is capable of shifting to a double unlocking position where the opening link 22 can be permitted to shift in a locking direction and a double locking position where the opening link 22 staying in the locking position cannot be permitted to shift in a direction towards the unlocking position; and a switch plate 29 having a female connector 219 to which an outside energizing connector (omitted from illustration) is connected. The locking and unlocking lever 18 and the opening link 22 correspond to the locking and unlocking mechanism according to the invention.

The worm wheel 16 rotates forwards and backwards from a neutral position against a biasing force of a spring 30 as the locking and unlocking motor 13 rotates forwards and backwards. Then, when the locking and unlocking motor 13 stops rotating, the worm wheel 16 automatically returns to the neutral position from the position to which the worm wheel 16 has rotated by virtue of the biasing force of the spring.

The locking and unlocking lever 18 has a toothed portion 181 that meshes with a toothed portion 161 provided at a central portion of the worm wheel 16. Then, when the worm wheel 16 rotates forwards and backwards based on an operation of the locking and unlocking motor 13, the locking and unlocking lever 18 is rotated to the locking position where a door opening operation through the outside handle and the inside handle are made possible and the locking position where the door opening operation of the outside handle and the inside handle is made impossible.

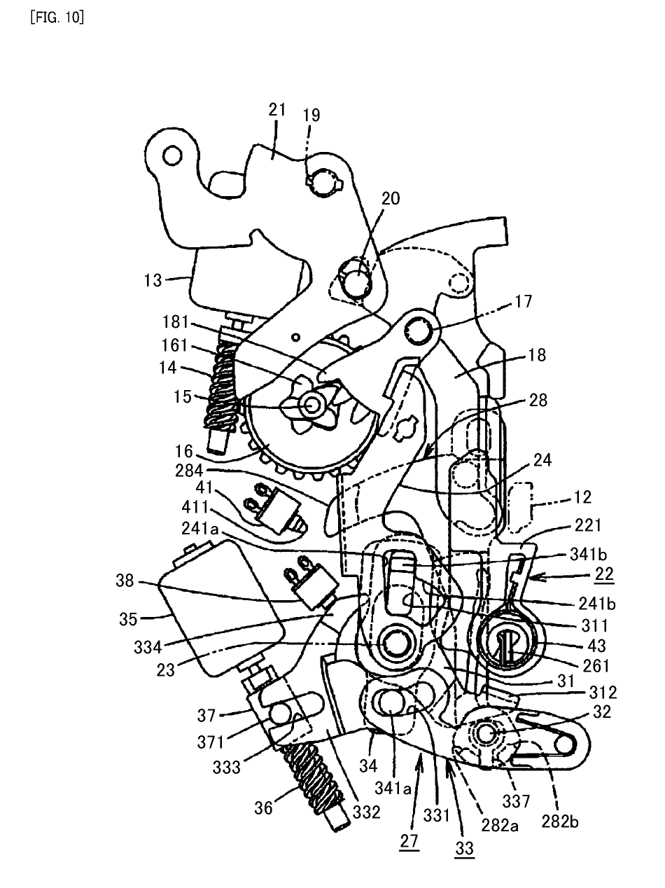

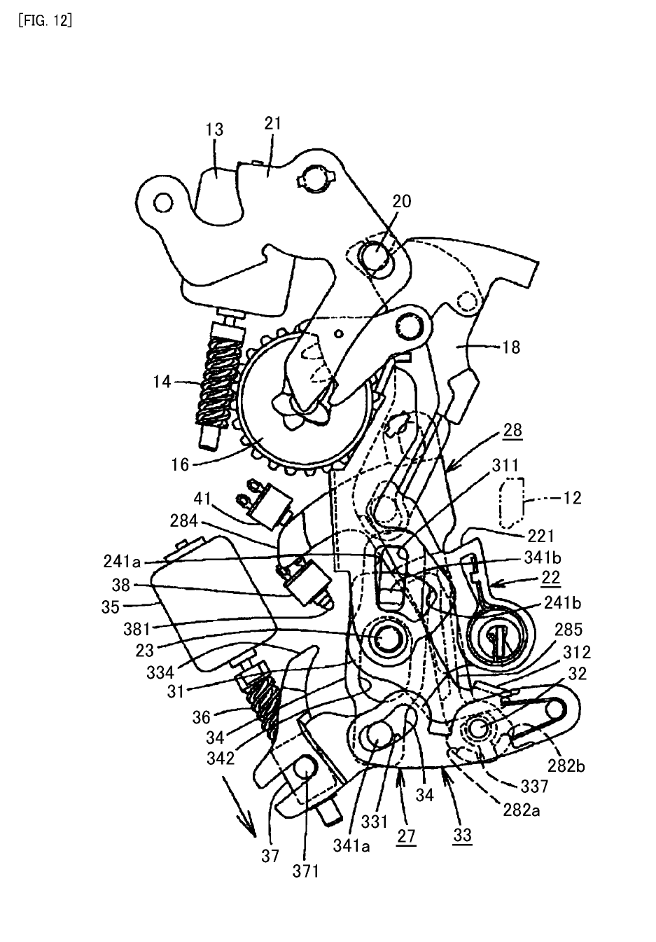

The knob lever 21 can rotate to an unlocking position to a locking position based on an unlocking operation and a locking operation of the lock knob. When the lock knob is operated for locking, the knob lever 21 rotates a predetermined angle in a counterclockwise direction from the unlocking position shown in FIG. 1 to shift to the locking position (refer to FIG. 12). As this occurs, the locking and unlocking lever 18 coupled to the knob lever 21 and the opening link 22 coupled to the locking and unlocking lever 18 are rotated to the unlocking positions where a door opening operation by the outside handle and the inside handle is made possible and the locking positions where the door opening operation by the outside handle and the inside handle is made impossible (refer to FIGS. 10, 12).

The inside lever 24 is disposed between the opening link 22 and a child proof and double locking motor 35, which will be described later, so that when the inside handle is operated to open the door, the inside lever 24 rotates in a counterclockwise direction in FIG. 1 against a biasing force of a spring 42. With the locking and unlocking lever 18 staying in the unlocking position and the child proof locking mechanism 27 staying in the child proof unlocking state, the inside lever 24 rotates the opening lever 12 in a releasing direction via a releasing lever 31, which will be described later, linked with the inside lever 24 and the opening link 22 to thereby release an engagement between the ratchet 11 and the latch 9, whereby the door can be opened.

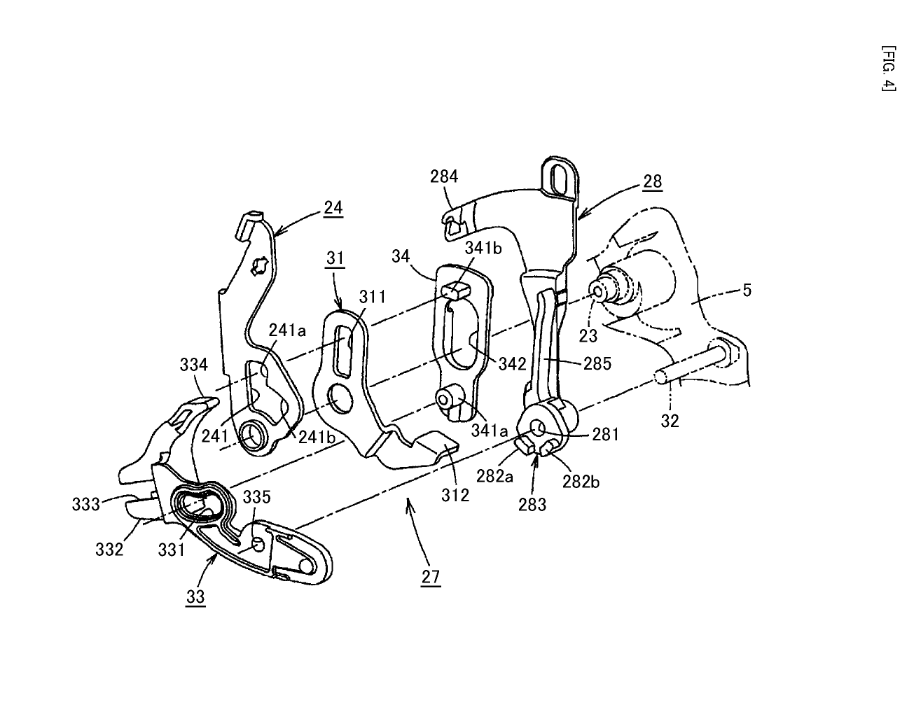

A generally L-shaped fitting hole 241 is formed in a lower portion of the inside lever 24 lying nearer to the shaft 23 so that an upper coupling projecting portion 341b provided on a connecting lever 34, which will be described later, can fit in this fitting hole 241 (refer to FIG. 4). With the child proof locking mechanism 27 staying the child proof unlocking state, the upper coupling projecting portion 341b fits in a vertical elongated hole portion 241a that is formed in an upper portion of the fitting hole 241 so as to be directed in a vertical direction so as to move in the vertical direction, so that when the inside handle is operated to open the door, a driving force of the inside lever 24 in the releasing direction can be transmitted to the releasing lever 31, which will be described later, via the upper coupling projecting portion 341b. In addition, when the child proof locking mechanism 27 is put in the child proof locking state, the upper coupling projecting portion 341b moves downwards to a wide rearwardly directed hole portion 241b that is formed at a lower portion of the fitting hole 241 so as not only to be contiguous with the vertical elongated hole portion 241a but also to be directed to the rear (an opposite direction to the releasing operating direction of the inside lever). Due to this, when the inside handle is operated to open the door, the inside lever 24 operates idly, whereby a releasing operation of the inside lever 24 is prevented from being transmitted to the releasing lever 31 via the upper coupling projecting portion 341b (a detailed description will be made later).

The opening link 22 is coupled to a coupling end portion 261 on an inner side of the outside lever 26 at a lower portion thereof so as to rotate a predetermined angle in the front and rear direction and is coupled the locking and unlocking lever 18 at an upper end portion thereof so as to move in the vertical direction. Due to this configuration, the opening link 22 rotates about the coupling end portion 261 of the outside lever 26 to the locking position that lies a predetermined angle away in the counterclockwise direction from the unlocking position shown in FIG. 1 against a biasing force of a spring 43. When the opening link 22 stays in the unlocking position, an upper surface of a release releasing portion 221 that is provided at a vertically middle portion of the opening link 22 can be brought into abutment with a lower surface of a release released portion 121 of the opening lever 12.

In the case where the door is in the closed state with the locking and unlocking lever 18 and the opening link 22 staying in the unlocking positions, when the outside lever 26 is activated to perform a releasing operation based on a door opening operation of the outside handle, the opening link 22 shifts upwards to rotate the opening lever 12 in the releasing direction, whereby a meshing engagement of the ratchet 11 that rotates together with the opening lever 12 with the latch 9 is released, enabling the door to be opened (refer to FIG. 10).

Additionally, in the case where the door is locked in a totally closed state, when the locking and unlocking motor 13 is activated to rotate in the locking direction and the locking and unlocking lever 18 and the opening link 22 are shifted to the locking positions, even though the opening link 22 shifts upwards as a result of the outside lever 26 performing the releasing operation, since the release releasing portion 221 shifts idly relative to the release released portion of the opening lever 12, the door cannot be opened (refer to FIG. 12).

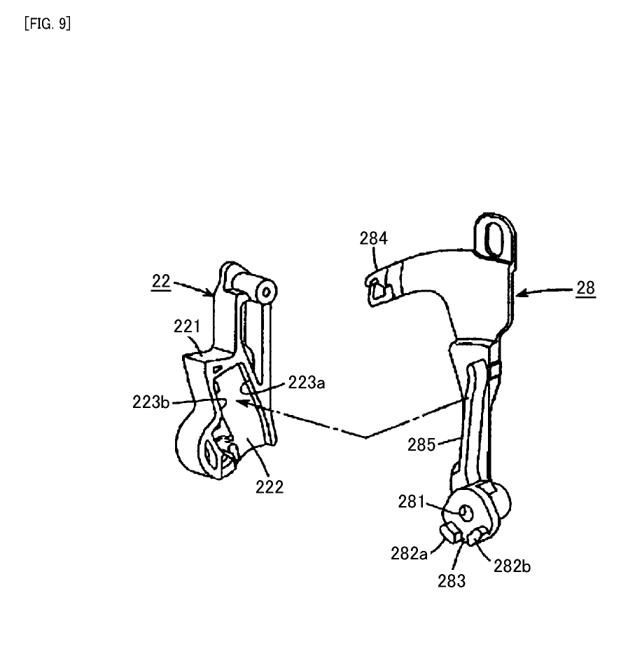

As also shown in FIGS. 4 and 9, the child proof locking mechanism 27 includes the releasing lever 31, the child proof lever 33 and the vertical connecting lever 34. The releasing lever 31 is supported rotatably on the shaft 23 of the inside lever 24 at a middle portion thereof so as to be superposed on a surface on a side facing the outside of the vehicle or an outer side of the inside lever 24 and has a vertically elongated hole 311 formed in a portion situated further upwards than the shaft 23. The child proof lever 33, which is directed in the front and rear direction and is made from a synthetic resin, is supported rotatably on a support shaft 32 provided on the casing 5 so as to be directed in the inside and outside direction of the vehicle at a middle portion in the front and rear direction inside a lower end portion of the casing 5 that is situated nearer to the rear. The connecting lever 34 is provided so as not only to be superposed on a surface on a side facing the outside of the vehicle or an outer side of the releasing lever 31 but also to shift vertically. The connecting lever 34 has a lower coupling projecting portion 341a and the upper coupling projecting portion 341b, both of which are directed towards inside of the vehicle, at lower and upper end portions thereof, respectively, and includes a vertical through hole 342 through which the shaft 23 penetrates between both the coupling projecting portions 341a, 341b. An inboard end portion of the support shaft 32 is supported on an inner surface of the cover 4, and an outboard end portion of the support shaft 32 is supported on an inner surface of the casing 5.

A releasing portion 312 is formed integrally at a rear end portion of the releasing lever 31 so as to be directed towards the outside of the vehicle, and this releasing portion 312 is brought into abutment with a lower end of the opening lever 22 to thereby shift the opening lever 22 upwards (in the releasing direction).

The upper coupling projecting portion 341b of the connecting lever 34 passes slidably through the elongated hole 311 in the releasing lever 31 and is then fitted in the fitting hole 241 in the side lever 24. The lower coupling projecting portion 341a of the connecting lever 34 is slidably fitted in an arc-shaped coupling hole 331 that formed in a position lying nearer to a front portion of the child proof lever 33 below the shaft 23 so as to be long in the front and rear direction.

The child proof and double locking motor 35 that can rotate forwards and backwards is accommodated in a front lower portion inside the casing 5 with its rotational axis inclined downwards to the front. A cylindrical shifting member 37 is screwed on a spiral gear 36 that is secured to a rotational shaft of the motor 35, and this cylindrical shifting member 37 shifts in an axial direction as the spiral gear 36 rotates forwards and backwards. A pair of driving pins 371 directed in the inside and outside direction of the vehicle is provided on the shifting member 37 so as to project therefrom.

Bifurcate coupling portions 332 are formed at a front end portion of the child proof lever 33 so as to hold the shifting member 37 therebetween. U-shaped cut-out grooves 333 formed in the coupling portions 332 are fitted on the pair of driving pins 371 of the shifting member 37 from the rear, whereby the shifting member 37 is coupled to the front end portion of the child proof lever 33. Detecting lever portions 334 extending upwards to the rear are formed at the front end portion of the child proof lever 33 so as to be integrated continuously with the corresponding coupling portions 332.

When the child proof lever 33 stays in a child proof unlocking position shown in FIG. 1, front faces of upper end portions of the detecting lever portions 334 are in contact with a switch pin 381 of a child proof locking detecting switch 38 provided at the lower end portion of the switch plate 29 in such a way as to push the switch pin 381 in, whereby the child proof locking detecting switch 38 detects a child proof unlocking state is detected. In addition, when the operation of the child proof and double locking member 35 causes the child proof lever 33 to rotate in a counterclockwise direction from the child proof unlocking position shown in FIG. 1 to a child proof locking position, the front surfaces of the upper end portions of the detecting lever portions 334 move downwards away from the switch pin 381, whereby the child proof locking detecting switch 38 detects a child proof locking state (the details will be described later).

The switch plate 29 is made up of a first switch plate 292 that energizes the locking and unlocking motor 13, a door opening and closing detecting switch 39 and a locking and unlocking detecting switch 40 and a second switch plate 293 that energizes the child proof and double locking motor 35, the child proof locking detecting switch 38 and a double locking detecting switch 41. The second switch plate 293 is coupled to the first switch plate 292. The door opening and closing detecting switch 39 and the locking and unlocking detecting switch 40 are attached to the first switch plate 292, and the child proof locking detecting switch 38 and the double locking detecting switch 41 are attached to the second switch plate 293 (refer to FIG. 1).

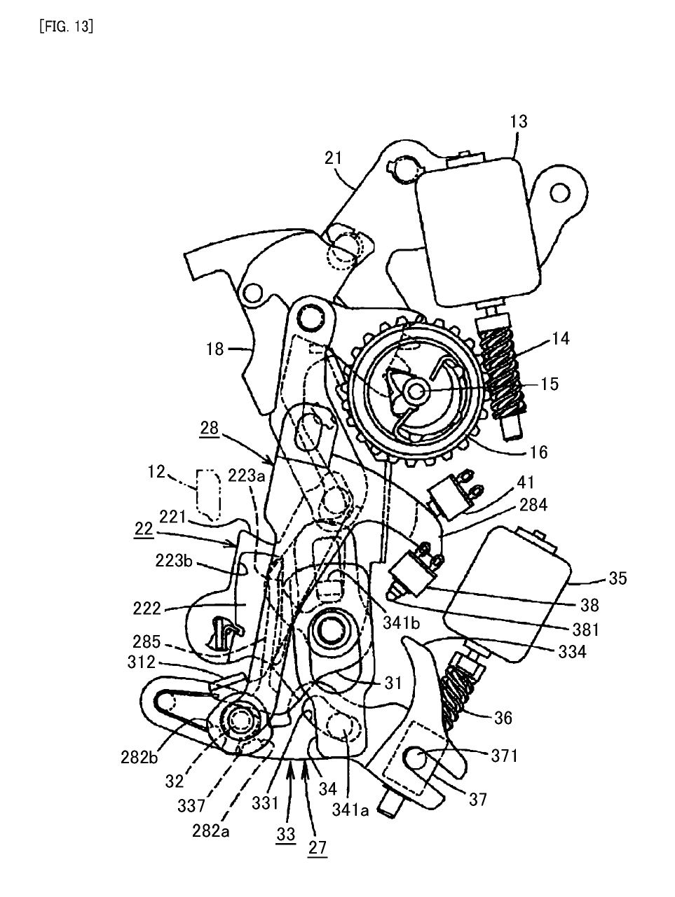

As shown in FIGS. 9 and 13, a vertical recess portion 222, which is opened downwards and towards the outside of the vehicle, is formed at a lower half portion of a lateral surface of a side facing the outside of the vehicle or an outer side of the opening link 22. A vertically directed rib-shaped blocking portion 285 is provided on a lateral surface on a side facing the inside of the vehicle or an inner side of the double locking lever 28 that faces the opening link 22 at a vertical portion thereof so as to project therefrom. An upper half portion of the rib-shaped blocking portion 285 is fitted in the recess portion 222 with such a play that allows the blocking portion 285 to move relatively in the front and rear direction within the recess portion 222.

When the opening link 22 and the double locking lever 28 stay in the unlocking positions shown in FIGS. 1 and 10, the blocking portion 285 of the double locking lever 28 faces a front blocked wall portion 223a, which is a blocked portion, while lying close to or in abutment with the blocked wall portion 223a within the recess portion 222 of the opening link 22. However, the blocking portion 285 lies spaced apart from a rear wall portion 223b of the recess portion 222. This permits the opening link 22 to shift in a direction towards the locking position (a counterclockwise direction) from the unlocking position shown in FIGS. 1 and 10, based on the locking operation performed by the knob lever 21 when the double locking lever 28 stays in the double unlocking position. Although the details will be described later, even in the case where the opening link 22 stays in the locking positions and the double locking lever 28 is shifted to the double locking position, the blocking portion 285 of the double locking lever 28 lies close to or in abutment with the front blocked wall portion 223a of the opening link 22 so as to block a shift of the opening link 22 in a direction towards the unlocking position.

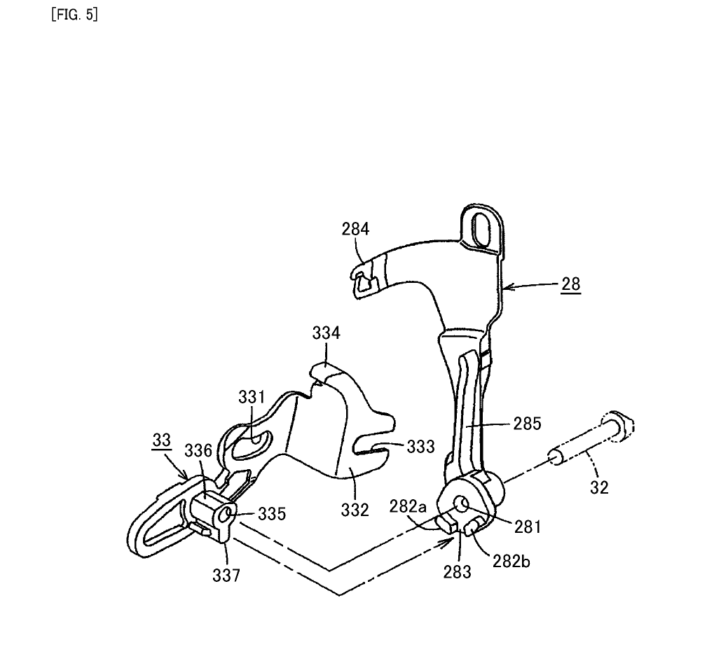

As shown in FIGS. 4 to 8, a shaft hole 281 extending in the front and rear direction is formed in a lower end portion of the double locking lever 28. Fitting rotatably this shaft hole 281 on the support shaft 32 supporting the child proof lever 33 allows the double locking lever 28 to be supported on the support shaft 32 together with the child proof lever 33 in such a manner that a part of the vertically directed portion thereof overlaps the outer lateral surface of the opening link 22. Two front and rear driven projecting portions 282a, 282b are provided on a lateral surface on a side facing the inside of the vehicle or an inner side of a central portion supported by the support shaft 32 that constitutes the lower end portion of the double locking lever 28 so as to project therefrom. These driven projecting portions 282a, 282b are spaced apart from each other in a circumferential direction about the shaft hole 281 as a center and project towards the inside of the vehicle. A gap 283 of a required width is formed between surfaces of both the driven projecting portions 282a, 282b that face each other, and this gap 283 is opened to the inside of the vehicle and at a top and a bottom thereof.

On the other hand, a projecting portion 336, directed to the outside of the vehicle and having a shaft hole 335 formed therein, is formed on a lateral surface on a side facing the outside of the vehicle or an outer side of a portion of the child proof lever 33 that faces the lower end portion of the double locking lever 28, that is, the central portion of the child proof lever 33 that is supported on the support shaft 32. A plate-shaped driving projecting portion 337 is provided integrally on a lower surface of the projecting portion 33b so as to project downwards therefrom. The driving projecting portion 337 has such a thickness that allows an outboard distal end portion of the driving projecting portion 337 to fit between the driven projecting portions 282a, 282b of the double locking lever 28 with a sufficient clearance when the shaft hole 281 of the double locking lever 28 and the shaft hole 335 of the child proof lever 33 are fitted on the support shaft 32.

Although the details will be described later, a link between the driving projecting portion 337 and the driven projecting portion 282a, 282b and a link between the child proof lever 33 and the double locking lever 28 are as follows.

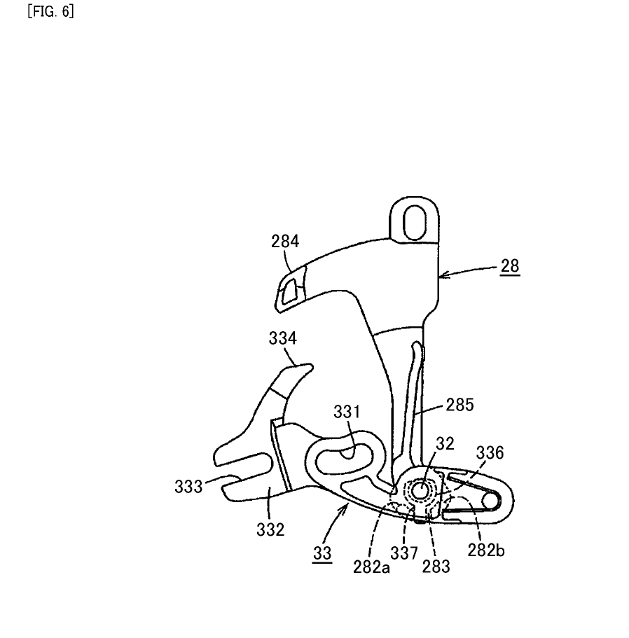

When the child proof lever 33 stays in a first position (a child proof unlocking position) shown in FIGS. 1 and 10, as shown in an enlarged fashion in FIG. 6, the driving projecting portion 337 that fits in the gap 283 in the double locking lever 28 lies close to or in abutment with the front driven projecting portion 282a while being spaced apart from the rear driven projecting portion 282b.

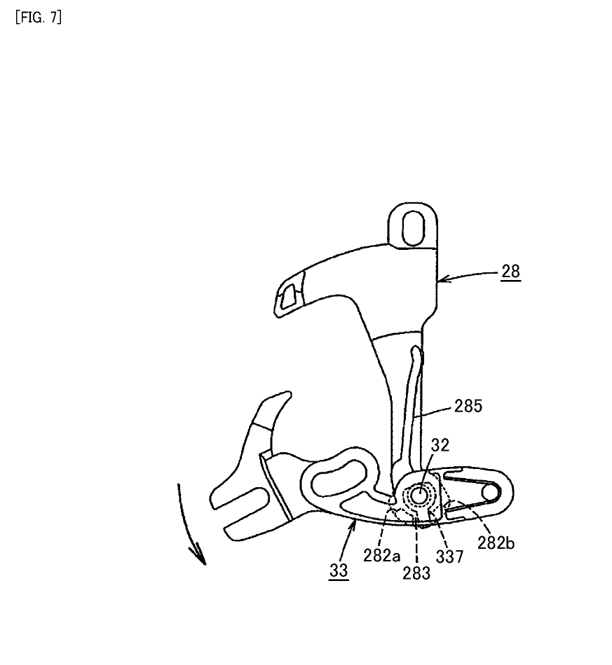

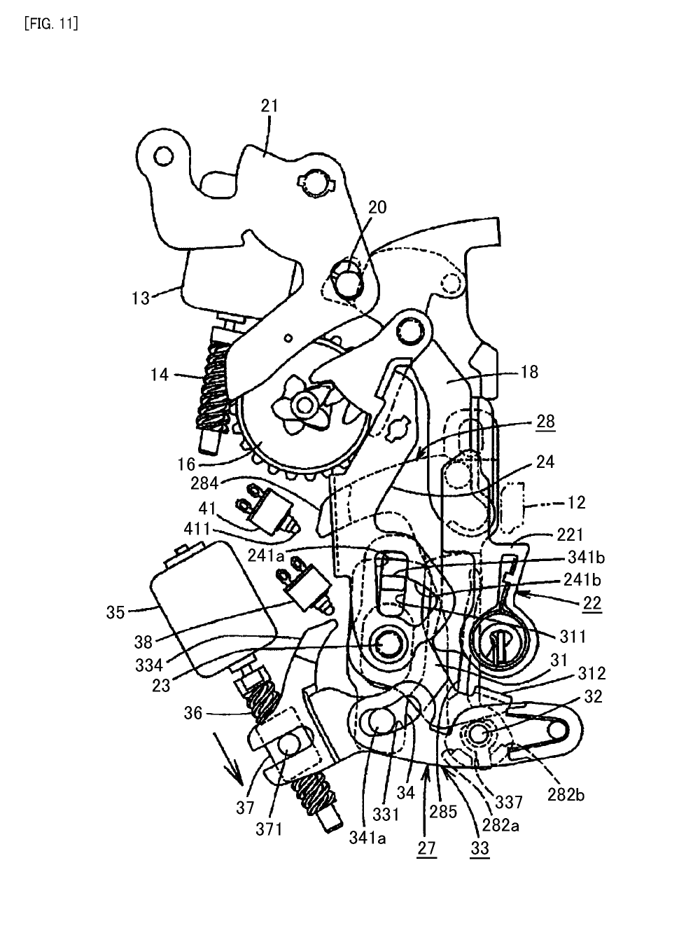

As shown in FIG. 11, when the child proof lever 33 is caused to rotate in a counterclockwise direction from the first position to a second position (a child proof locking position) by the child proof and double locking motor 35, the driving projecting portion 337 only rotates to a position where the driving projecting portion 337 lies close to or in abutment with the rear driven projecting portion 282b within the gap 283, and a rotational force of the child proof lever 33 is not transmitted to the double locking lever 28, as shown in FIG. 7.

As shown in FIG. 11, when the child proof lever 33 is caused to rotate further in the counterclockwise direction from the second position to a third position (a double locking position) by the child proof and double locking motor 35, a rotational driving force of the driving projecting portion 337 is transmitted to the rear driven projecting portion 282b, whereby the double locking lever 28 is caused to rotate in the counterclockwise direction about the support shaft 32 as the child proof lever 33 so rotates and is put in a double locking state.

Next, the operations of the child locking mechanism 27 and the double locking lever 28 will be described in detail.

When the child locking mechanism 27 stays in the child proof unlocking state, the child proof lever 33 stops in the first position (the child proof unlocking position) shown in FIGS. 1 and 9. In this case, as described above, the upper coupling projecting portion 341b of the connecting lever 34 passes through the elongated hole 311 of the releasing lever 31 to fit in the vertical elongated hole portion 241a of the inside lever 24. Consequently, with the locking and unlocking lever 18 and the opening link 22 staying in the unlocking positions, when the inside lever 24 is activated to perform a releasing operation in the door opening direction (the counterclockwise direction in FIGS. 1 and 9) based on a door opening operation by the inside handle, not shown, a driving force of the inside lever 24 is transmitted to the releasing lever 31 by way of the upper coupling projecting portion 341b, whereby the releasing lever 31 rotates in the counterclockwise direction in association with the inside lever 24. This brings the releasing portion 312 of the releasing lever 31 into abutment with a lower end of the opening link 22 to thereby push up the opening link 22. This rotates the opening lever 12 in the releasing direction, whereby the meshing engagement between the latch 9 and the ratchet 11 is released, and the door can be opened.

On the other hand, as shown in FIG. 10, when the child proof locking mechanism 27 is put in the child proof locking state, that is, when the child proof lever 33 is rotationally shifted in the counterclockwise direction to the second position (the child proof locking position) through rotation of the spiral gear 36 by activating the child proof and double locking motor 35 to rotate in the locking direction by operating the remote control switch or the like provided on the driver's seat side to activate a child proof locking operation or as a result of a predetermined condition being satisfied that is determined in association with vehicle speed, parking range, foot brake and the like, the connecting lever 34 is shifted downwards via the lower coupling projecting portion 341a that fits in the coupling hole 331 of the child proof lever 33. Then, the upper coupling projecting portion 341a falls down to an upper portion of the rearwardly directed hole portion 241b of the fitting hole 241 of the inside lever 24. When the child proof lever 33 shifts to the child proof locking position, which is the second position, the detecting lever portions 334 move away from the switch pin 381 of the child proof locking detecting switch 38, and a child proof locking signal is sent to a control circuit unit or the like, whereby the child proof and double locking motor 35 stops.

When the child proof lever 33 shifts to the second position, the door lock apparatus 1 is put in the child proof locking state, and the locking and unlocking lever 18 is put in the unlocking state by activating the lock knob, not shown, inside the door to perform an unlocking operation. Even though the inside lever 24 is operated in the releasing direction, the inside lever 24 only operates idly, whereby the driving force of the inside lever 24 is not transmitted to the releasing lever 31 by way of the upper coupling projecting portion 341b. Thus, when the door lock apparatus 1 is in the child proof locking state, since the opening lever 12 cannot be shifted in the releasing direction by way of the releasing lever 31 and the opening link 22, even though a child operates the inside lever 24 from the inside of the vehicle to activate a releasing operation, the door cannot be opened. Although the door lock apparatus 1 stays in the child proof locking state, when the locking and unlocking lever 18 stays in the unlocking position, the opening lever 12 can be shifted in the releasing direction via the opening link 22 by operating the outside handle of the door to activate the outside lever 26 to perform a releasing operation in a door opening direction, whereby the door can be opened from the outside of the vehicle. Additionally, as described above, when the child proof lever 33 rotationally shifts to the child proof locking position, which is the second position, and stops there, as shown in FIG. 7, the driving projecting portion 337 provided on the child proof lever 33 only shifts towards the rear driven projecting portion 282b within the gap 283 provided in the double locking lever 28. Therefore, the driving force of the child proof lever 33 by the child proof and double locking motor 35 is never transmitted to the double locking lever 28. When the child proof locking state is released, the child proof and double locking motor 35 is caused to rotate in an opposite direction to the locking direction described above, that is, in the unlocking direction by operating the remote control switch or the like provided on the driver's seat side to activate a child proof unlocking operation or as a result of a predetermined condition being satisfied that is determined in association with vehicle speed, parking range, foot brake and the like to thereby cause the child proof lever 33 to shift to the first position, whereby the door lock apparatus 1 can be switched to the child proof unlocking state.

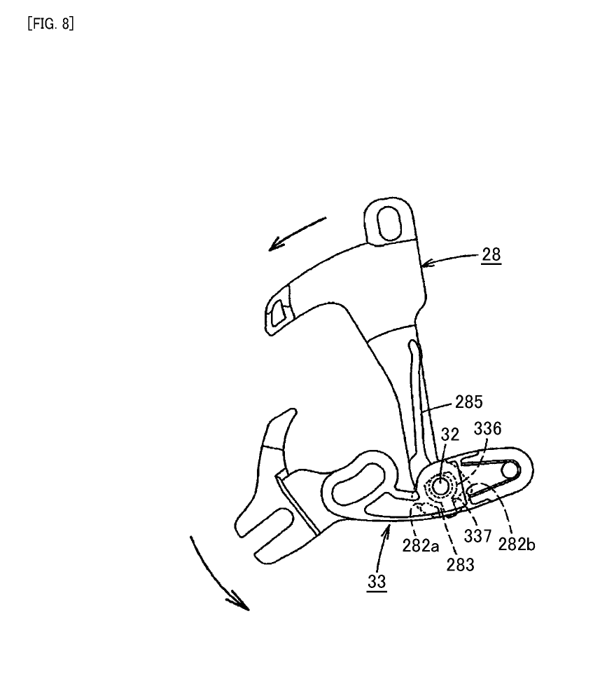

When the door is totally closed, with the locking and unlocking lever 18 and the opening link 22 staying in the locking positions, a portable remote control switch is operated to activate a double locking operation, and the child proof and double locking motor 35 is activated to rotate in the locking direction, whereby the child proof lever 33 rotationally shifts from the first position through the second position to the third position (the double locking position), as shown in FIG. 11. Then, as described above, the driving projecting portion 337 of the child proof lever 33 that fits in the gap 283 of the double locking lever 28 is brought into abutment with the rear driven projecting portion 282b that lies in the rotational direction of the driving projecting portion 337, as shown in FIGS. 8 and 12, whereby the double locking lever 28 is rotated a predetermined angle in a double locking direction (a counterclockwise direction in FIG. 11) about the support shaft 32 in association with the child proof lever 33.

When the double locking lever 28 rotates to the double locking position, a distal end portion of a detecting lever portion 284 that is formed at an upper end portion of the double locking lever 28 so as to extend to the front is brought into contact with a switch pin 411 of a double locking detecting switch 41 attached to the second switch plate 293 to push it in, whereby a double locking signal is sent to the control circuit unit or the like, and the child proof and double locking motor 35 stops.

When the double locking lever 28 shifts rotationally to the double locking position, as shown in FIG. 13 (a view as seen from a rear side of FIG. 12), an upper end portion of the blocking portion 285 provided on the double locking lever 28 comes to face the front (right side in FIG. 13) blocked wall portion 223a of the recess portion 222 while lying close to or in abutment therewith within the recess portion 222 of the opening link 22 that shifts to the locking position together with the locking and unlocking lever 18, whereby the door lock apparatus 1 is switched to the double locking state.

With the door lock apparatus 1 staying in the double locking state, even though the lock knob inside the vehicle is activated to perform an unlocking operation, the locking and unlocking lever 18 and the opening link 22 that is linked with the locking and unlocking lever 18 are prevented from shifting from the locking positions to the unlocking positions. Namely, with the door lock apparatus 1 staying in the double locking state, when the lock knob is activated to perform an unlocking operation and the locking and unlocking lever 18 and the opening link 22 attempt to shift in the unlocking direction (the positions shown in FIGS. 1 and 10), as shown in FIG. 13, the front blocked wall portion 223a of the opening link 22 is brought into abutment with the blocking portion 285 of the double locking lever 28 that stops in the double locking position, whereby a shift of the opening link 22 and the locking and unlocking lever 18 in a direction towards the unlocking position is blocked.

Due to this, with the door lock apparatus 1 staying in the double locking state, there is caused no fear that the door is opened even though the outside handle of the door is activated to open the door or the lock knob inside the vehicle is operate improperly in the direction towards the unlocking position from the outside of the vehicle. When the double locking state is released by shifting the double locking lever 28 in the direction towards the double unlocking position, the portable remote control switch or the like is operated to activate an unlocking operation to activate the child proof and double locking motor 35 to operate in the opposite direction to the locking direction, that is, in the unlocking direction so that the child proof lever 33 is caused to shift from the third position to the first position. As this occurs, the double locking lever 28 is driven in the direction towards the double unlocking position as a result of the driving projecting portion 337 of the child proof lever 33 being brought into abutment with the front driven projecting portion 282a of the double locking lever 28 that lies in the rotating direction of the driving projecting portion 337.

In the door lock apparatus 1 that has been described heretofore, the child proof lever 33 of the child proof locking mechanism 27 and the double locking lever 28 are supported coaxially on the support shaft 32 that extends in the inside and outside direction of the vehicle. Then, the double locking lever 28 is interlocked with the child proof lever 33 by means of the interlocking elements provided on the facing surfaces of the central portions thereof, so that the double locking lever 28 and the child proof lever 33 are driven together directly in the double locking positions and the double unlocking positions. This enables the child proof locking mechanism 27 and the double locking lever 28 to be accommodated close to each other in a compact fashion within the casing 5, thereby making it possible to make the casing 5 and the door lock apparatus smaller in size.

In addition, the child proof locking mechanism 27 can be switched to the child proof locking state and the child proof unlocking state and the double locking lever 28 can be shifted to the double locking position and the double unlocking position only by driving directly the child proof lever 33 of the child proof locking mechanism 27 by the child proof and double locking motor 35 and shifting the child proof lever 33 to the first position, the second position and the third position 3 reached through the second position and reversely. This simplifies the child proof locking mechanism and the double locking mechanism.

Further, the releasing lever 31 and the connecting lever 34 that make up the child proof locking mechanism 27 are disposed so as to be superposed on the inside lever 24 between the opening link 22 and the child proof and double locking motor 35 and are assembled together while being supported on the shaft 23 that supports the inside lever 24 in the upper position lying close to the child proof lever 33. Due to this, the constituent members of the child proof locking mechanism 27 are collected between the opening link 22 and the child proof and double locking motor 35, thereby making it possible to make the door lock apparatus much smaller in size.

The interlocking elements with which the child proof lever 33 and the double locking lever 28 are linked with each other in an interlocked fashion are made up of the driving projecting portion 337 that is provided on the child proof lever 33 side and the two driven projecting portions 282a, 282b that are provided on the double locking lever 28 side to define the gap 283 into which the driving projecting portion 337 fits. When the child proof lever 33 passes through the second position to reach the third position, the driving projecting portion 337 comes into abutment with the driven projecting portion 282b, and when the child proof lever 33 shifts from the third position to the first position, the driving projecting portion 337 comes into abutment with the driven projecting portion 282a. This enables the double locking lever 28 to shift in the direction towards the double locking position and in the direction towards the double unlocking position as the child proof lever 33 so shifts. This simplifies the configurations of the interlocking elements. Moreover, the driving projecting portion 337 and the driven projecting portions 282a, 282b are provided integrally on the facing surfaces of the central portions of the child proof lever 33 and the double locking lever 28 where both the levers are supported on the support shaft 32. This enables the interlocking elements to be arranged compact about the support shaft 32.

The opening link 22 and the double locking lever 28 are disposed so as to face each other partially. In the case where the opening link 22 stays in the locking position, and the double locking lever stays in the double locking position, the blocking portion 285 provided on the surface of the double locking lever 28 that faces the corresponding surface of the opening link 22 lies close to or in abutment with one of the two blocked wall portions, that is, the blocked wall portion 223a within the recess portion 222 provided on the surface of the opening link 22 that faces the corresponding surface of the double locking lever 28, whereby a shift of the opening link 22 in the direction towards the unlocking position is blocked. Thus, the configuration of the linking mechanism is simplified which puts the door lock apparatus in the double locking state.

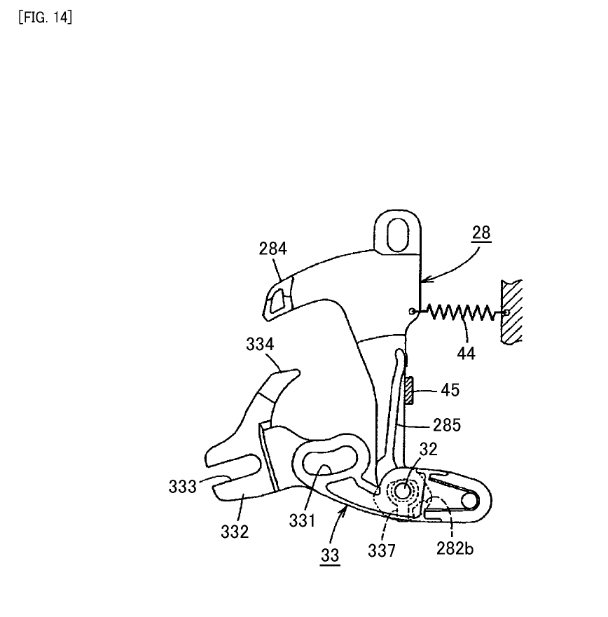

In the door lock apparatus 1, the interlocking elements with which the child proof lever 33 is linked with the double locking lever 28 in the interlocked fashion are made up of the driving projecting portion 337 that is provided on the child proof lever 33 side and the two driven projecting portions 282a, 282b that are provided on the double locking lever 28 side, and the gap 283 into which the driving projecting portion 337 fits is defined between the surfaces of the two driven projecting portions 282a, 282b that face each other. However, an interlocking mechanism shown in FIG. 14 may be adopted.

Namely, of the two driven projecting portions 282a, 282b that are provided on the double locking lever 28, the front driven projecting portion 282a is omitted, and only the rear driven projecting portion 282b is used. When the child proof lever 33 passes through the second position to reach the third position, as with the embodiment described heretofore, the driving projecting portion 337 that is provided on the child proof lever 33 side is brought into abutment with the driven projecting portion 282b, whereby the double locking lever 28 shifts in the direction towards the double locking position in the interlocked fashion as the child proof lever 33 so shifts. Additionally, a tension spring 44 or the like (a torsion spring fitted on the support shaft 32 may be adopted) that is locked on a stationary member such as the casing 5 or the like at one end is used as an element for shifting the double licking lever 28 in the direction towards the double unlocking position. Then, the double locking lever 28 that stays in the double locking position is caused to shift in the direction towards the double unlocking position by means of a biasing force of the tension spring 44 at the same time as the child proof lever 33 shifts from the third position to the first position and is stopped in the double unlocking position by a stopper 45 provided on the casing 5 or the like.

Next, an electric circuit including a control unit ECU according to the embodiment will be described.

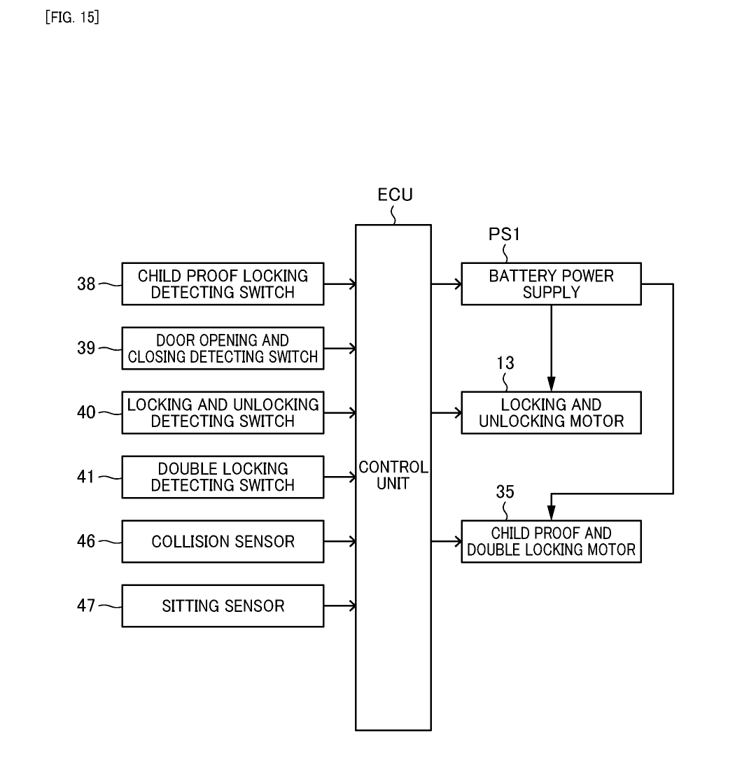

As shown in FIG. 15, the control unit ECU is configured as an integral one-chip CPU together with a ROM and a RAM functioning as a working area of the CPU and executes a series of control operations based on control programs stored in the ROM.

The child proof locking detecting switch 38, the door opening and closing detecting switch 39, the locking and unlocking detecting switch 40 and the double locking detecting switch 41 are each electrically connected to an input port of the control unit ECU so that signals are inputted into the control unit ECU from the switches. Further, a collision sensor 46 for detecting a collision of the motor vehicle and a sitting sensor 47 for detecting whether or not an occupant is sitting on a seat are each electrically connected to the input port of the control unit ECU so that signals are inputted into the control unit from the sensors. In addition, the locking and unlocking motor 13 and the child proof and double locking motor 35 are each electrically connected to an output port of the control unit ECU. Although illustrations thereof are omitted, the remote control switch for activating the locking and unlocking motor 13 and the remote control switch for activating the child proof and double locking motor 35 are also electrically connected to the input port of the control unit ECU so that signal are inputted into the control unit ECU from the remote control switches.

The collision sensor 46 is provided at several portions of the motor vehicle as required and detects a collision based on, for example, an acceleration exerted on the motor vehicle, sending a collision detection signal to the control unit ECU when the collision sensor 46 detects a collision.

The sitting sensor 47 is provided on a rear seat and detects an occupant sitting on the rear seat based on, for example, a load or a pressure exerted on a sitting surface of the rear seat, sending a sitting occupant detection signal to the control unit ECU when the sitting sensor 47 detects an occupant sitting on the rear seat.

When receiving a collision detection signal from the collision sensor 46, the control unit ECU controls to drive the locking and unlocking motor 13 to activate an unlocking operation to switch the door lock apparatus 1 in each rear side door to the unlocking state and also controls to drive the child proof and double locking motor 35 to activate an unlocking operation to switch the child proof locking mechanism 27 of the door lock apparatus 1 in each rear side door to the child proof unlocking state.

The control unit ECU is activated to operate by receiving a supply of electric power from a battery power supply PS1 mounted on the motor vehicle, and the locking and unlocking motor 13 and the child proof and double locking motor 35 are also activated to operate by receiving a supply of electric power from the battery power supply PS1 based on a driving control by the control unit ECU.

Next, an operation of the door lock apparatus 1 when the collision sensor 46 detects a collision will be described.

The collision sensor 46 that detects a collision sends a collision detection signal to the control unit ECU. When receiving the collision detection signal, the control unit ECU controls to drive the locking and unlocking motor 13 to switch the locking and unlocking mechanism of the door lock apparatus 1 to the unlocking state after a predetermined length of time has elapsed since the reception of the collision detection signal.

Further, the control unit ECU that receives the collision detection signal controls to drive the child proof and double locking motor 35 to switch the child proof locking mechanism 27 of the door lock apparatus 1 to the child proof unlocking state after a predetermined length of time has elapsed since the reception of the collision detection signal.

The locking and unlocking mechanism of the door lock apparatus 1 is switched to the unlocking state and the child proof locking mechanism 27 of the door lock apparatus 1 is switched to the child proof unlocking state as a result of the locking and unlocking motor 13 and the child proof and double locking motor 35 being driven to activate the unlocking operation by the driving control of the control unit ECU. The rear side door can be opened from the outside of the vehicle by operating the outside handle to open the rear side door as a result of the locking and unlocking mechanism being switched to the unlocking state. Further, the rear side door can also be opened from the inside of the vehicle by operating the inside handle to open the rear side door as a result of the child proof locking mechanism 27 being switched to the unlocking state.

These operations are automatically activated to be performed by the control unit ECU by taking opportunity of detecting the collision irrespective of an operation of the remote control switch on the driver's seat side for activating the locking and unlocking motor 13 and the child proof and double locking motor 35 to operate. Therefore, even in the event that there is no hope of the driver operating the remote control switch in such a situation that the driver is not allowed to reach the remote control switch, the rear side door can be opened without any delay.

A predetermined length of time from the detection of a collision to an execution of an unlocking driving control of the locking and unlocking motor 13 and the child proof and double locking motor 35 can be set as required in consideration of a length of time typically required from a collision of the motor vehicle to a stop thereof, and for example, 30 seconds is taken as the predetermined length of time. The locking and unlocking motor 13 and the child proof and double locking motor 35 are controlled to be driven to activate an unlocking operation after the predetermined length of time has elapsed, whereby it is possible to prevent an occurrence of a risk of the rear seat passenger being thrown out as a result of the door being opened inadvertently before the motor vehicle stops.

Although the locking and unlocking motor 13 may be controlled to be driven to activate an unlocking operation at the same time as the child proof and double locking motor 35 is controlled to be driven to activate an unlocking operation, preferably, the child proof and double locking motor 35 is controlled to be driven to activate an unlocking operation after the locking and unlocking motor 13 has been controlled to be driven to activate an unlocking operation.

In addition, in the door lock apparatus 1, the locking and unlocking mechanism can be switched to the unlocking state by operating the lock knob that is linked with the knob lever 21. In the case where the door lock apparatus 1 stays in the child proof unlocking state and the double unlocking state, it is considered that the rear seat passenger operates the lock knob by him or herself to switch the locking and unlocking mechanism to the unlocking state and then opens the rear side door to escape therethrough. Thus, in the case where the predetermined length of time has elapsed and the rear seat sitting passenger is detected by the sitting sensor 47, that is, in the case where the rear seat passenger remains sitting on the rear seat at the point of time when the predetermined length of time has elapsed, the control unit ECU may be configured to control to drive the locking and unlocking motor 13 and the child proof and double locking motor 35 to activate an unlocking operation

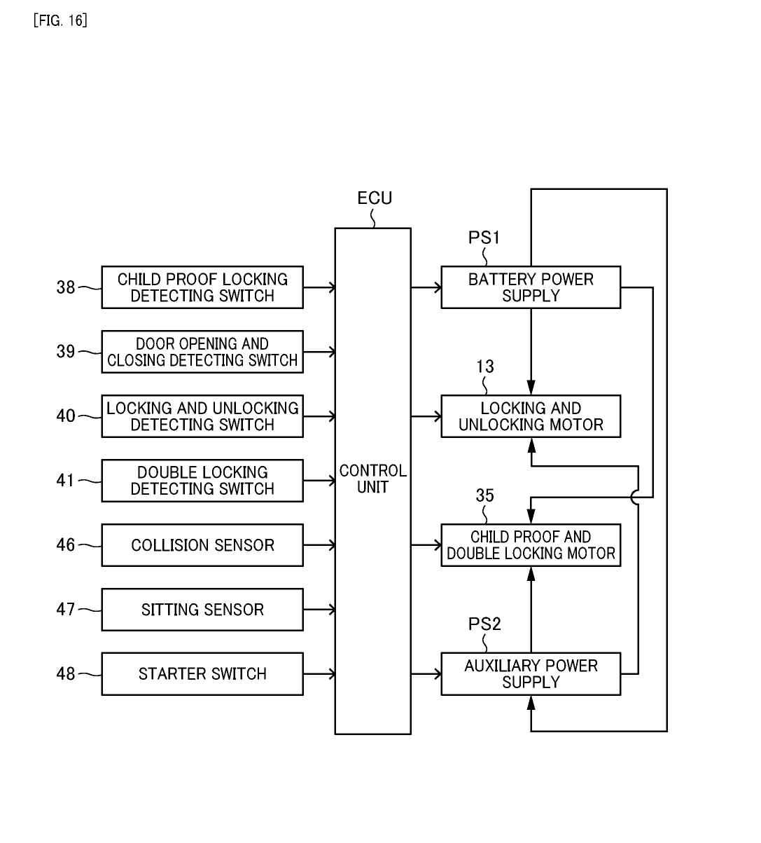

FIG. 16 shows a modified example of an electric circuit including the control unit ECU.

An example shown in FIG. 16 is such that an auxiliary power supply PS2 is provided to supply electric power to the locking and unlocking motor 13 and the child proof and double locking motor 35. Although the auxiliary power supply PS2 may be provided each for the locking and unlocking motor 13 and the child proof and double locking motor 35, it is preferable that the auxiliary power supply PS2 is made to supply electric power to both the locking and unlocking motor 13 and the child proof and double locking motor 35 to be used commonly by the locking and unlocking motor 13 and the child proof and double locking motor 35.

There is imposed no specific limitation to the type of the auxiliary power supply PS2 as long as a storage battery is used, however, a capacitor that is electrically charged without involving a chemical change can preferably be used because the capacitor is superior in efficiency and service life to a battery that involves a chemical change in charging and discharging.

The auxiliary power supply PS2 is electrically connected to the battery power supply PS1 and is charged with electric power that is supplied thereto from the battery power supply PS1 during a period while a starter switch 48 is kept on, during which an engine is operated or electrical equipment is operated.

Then, when controlling to drive the locking and unlocking motor 13 and the child proof and double locking motor 35, the control unit ECU can selectively switch the power supplies supplying electric power required to drive the motors between the battery power supply PS1 and the auxiliary power supply PS2.

In the configuration that has been described heretofore, the control unit ECU controls to drive the locking and unlocking motor 13 and the child proof and double locking motor 35 of the door lock apparatus 1 of each rear side door using the battery power supply PS1 as a power supply after the predetermined length of time has elapsed since the reception of the collision detection signal to activate an unlocking operation.

Here, in the event that the supply of electric power from the battery power source PS1 to the locking and unlocking motor 13 and the child proof and double locking motor 35 is cut off due to a disconnection of electric wires connecting the battery power supply PS1 to the locking and unlocking motor 13 and the child proof and double locking motor 35 in association with a collision, the locking and unlocking mechanism is left in the locking state because the locking and unlocking motor 13 to which no electric power is being supplied from the battery power supply PS1 cannot be driven to activate an unlocking operation. Similarly, the child proof locking mechanism 27 is left in the child proof locking state because the child proof and double locking motor 35 to which no electric power is being supplied from the battery power supply PS1 cannot be driven to activate an unlocking operation.

In the case where the locking and unlocking detection switch 40 detects that the locking and unlocking mechanism of the rear side door still stays in the locking state even after the locking and unlocking motor 13 has been controlled to be driven to activate an unlocking operation using the battery power supply PS1 as a power supply, the control unit ECU switches the power supply to the auxiliary power supply PS2 and then executes again the unlocking driving control of the locking and unlocking motor 13.

In the case where the child proof locking detecting switch 38 detects that the child proof locking mechanism 27 of the rear side door still stays in the child proof locking state even after the child proof and double locking motor 35 has been controlled to be driven to activate an unlocking operation, the control unit ECU switches the power supply to the auxiliary power supply PS2 and then executes again the unlocking driving control of the child proof and double locking motor 35.

The unlocking driving control of the locking and unlocking motor 13 using the auxiliary power supply PS2 as a power supply may be executed on all the rear side doors or may be executed only on the rear side door in which the locking and unlocking mechanism is detected to still stay in the locking state. Similarly, the unlocking driving control of the child proof and double locking motor 35 using the auxiliary power supply PS2 as a power supply may be executed to all the rear doors or may be executed only on the rear door in which the child proof locking mechanism 27 is detected to still stay in the locking state.

Thus, even in the event that the supply of electric power from the battery power supply PS1 to the locking and unlocking motor 13 and the child proof and double locking moor 35 is cutoff, the locking and unlocking motor 13 and the child proof and double locking motor 35 can be activated to operate using the auxiliary power supply PS2 as a power supply, thereby making it possible to enhance the certainty in operation of the door lock apparatus 1 in relation to a quick opening of the door from the inside and outside of the vehicle at the time of a collision.

Although the auxiliary power supply PS2 may be used commonly for the locking and unlocking motors 13 and the child proof and double locking motors 35 of all the rear side doors, it is preferable that the auxiliary power supply PS2 is provided for each of the rear side doors. Providing the auxiliary power supply PS2 for each of the rear side doors can reduce the length of electric wires connecting the auxiliary power supply PS2 to the locking and unlocking motor 13 and the child proof and double locking motor 35 to thereby reduce a risk of disconnection of the electric wires. Thus, it is possible to enhance further the certainty in operation of the door lock apparatus 1.

Thus, while the embodiment of the invention has been described by taking as an example the door lock apparatus 1 including the double locking mechanism and the child proof locking mechanism, the invention can be applied to any door lock apparatus, provided that it includes a child proof locking mechanism. Additionally, the following various modifications, alterations or combinations thereof can be made to the embodiment without departing from the spirit and scope of the invention.

(1) When the vehicle speed sensor detects that the vehicle starts running from a halt, the locking and unlocking motors 13 of the door lock apparatuses 1 of all the doors are controlled to be driven to activate a locking operation to switch the locking and unlocking mechanisms to the locking state.

(2) When the vehicle speed sensor detects that the vehicle starts running from a halt, the child proof and double locking motors 35 of the door lock apparatuses 1 of all the doors are controlled to be driven to activate a locking operation to switch the child proof locking mechanisms 27 to the locking state.

### REFERENCE SIGNS LIST

1 Motor vehicle door lock apparatus
2 Meshing unit
3 Actuator unit
4 Cover
5 Casing
6 Body
7 Cover plate
8 Latch shaft
9 Latch
9a Engaging groove
10 Ratchet shaft
11 Ratchet
12 Opening lever
13 Locking and unlocking motor
14 Worm
15 Shaft
16 Worn wheel
17 Shaft
18 Locking and unlocking lever
19 Shaft
20 Pin
21 Knob lever
22 Opening link
23 Shaft
24 Inside lever
25 Shaft
26 Outside lever
27 Child proof locking mechanism
28 Double locking lever
29 Switch plate
30 Spring
31 Releasing lever
32 Support shaft
33 Child proof lever
34 Connecting lever
35 Child proof and double locking motor
36 Spiral gear
37 Shifting member
38 Child proof locking detecting switch
39 Door opening and closing detecting switch
40 Locking and unlocking detecting switch
41 Double locking detecting switch
42, 43, 44 Spring
45 Stopper
46 Collision sensor
47 Sitting sensor
48 Starter switch
121 Release released portion
161, 181 Toothed portion
221 Release releasing portion
222 Recess portion
223a Blocked wall portion (Blocked portion)
223b Wall portion
241 Fitting hole
241a Vertical elongated hole portion
241b Rearwardly directed hole portion
261 Coupling end portion
281 Shaft hole
282a, 282b Driven projecting portion (Driven portion)
283 Gap
284 Detecting lever portion
285 Blocking portion
291 Female connector
292 First switch plate
293 Second switch plate
311 Elongated hole
312 Releasing portion
331 Coupling hole
332 Coupling portion
333 Cut-out groove
334 Detecting lever portion
335 Shaft hole
336 Projecting portion
337 Driving projecting portion (Driving portion)
341a Lower coupling projecting portion (Lower coupling portion)
341b Upper coupling projecting portion (Upper coupling portion)
342 Through hole
371 Driving pin
381, 411 Switch pin
D1, D2 Operation force transmitting member
S Striker.

1. A motor vehicle door lock apparatus comprising:
a meshing mechanism configured to mesh with a striker to hold a door in a closed state;
a locking and unlocking mechanism configured to be switched by a driving of a locking and unlocking motor to:
an unlocking state where a meshing of the meshing mechanism can be released through an operation of an outside mechanical operation element provided on a side facing an outside of a motor vehicle or an outer side of the door and an operation of an inside mechanical operation element provided on a side facing an inside of the motor vehicle or an inner side of the door; and
a locking state where the meshing of the meshing mechanism cannot be released;
a child proof locking mechanism configured to be switched only by a driving of a child proof locking motor to:
a child proof unlocking state where the meshing of the meshing mechanism can be released through the operation of the outside mechanical operation element and the meshing of the meshing mechanism can be released through an operation of the inside mechanical operation element when the meshing mechanism stays in the unlocking state: and
a child proof locking state where the meshing of the meshing mechanism can be released through the operation of the outside mechanical operation element and the meshing of the meshing mechanism cannot be released through the operation of the inside mechanical operation element; and
a control unit configured to, after a predetermined length of time elapses since a collision detector configured to detect a collision of the motor vehicle detects the collision,
drive the locking and unlocking motor to activate the unlocking operation to switch the locking and unlocking mechanism to the unlocking state, and
drive the child proof locking motor to activate the unlocking operation to switch the child proof locking mechanism to the child proof unlocking state.

2. The motor vehicle door lock apparatus according to claim 1,
wherein the control unit is configured to drive the locking and unlocking motor to activate the unlocking operation, and then drive the child proof locking motor to activate the child proof unlocking operation.

3. The motor vehicle door lock apparatus according to claim 1,
wherein the control unit is configured to drive the locking and unlocking motor and the child proof locking motor to activate the unlocking operation when the predetermined length of time has elapsed since the detection of the collision by the collision detector and sitting detector configured to detect a presence of a sitting occupant detects a presence of the sitting occupant.

4. The motor vehicle door lock apparatus according to claim 1,
wherein the locking and unlocking motor and the child proof locking motor are driven by electric power supplied from a battery power supply mounted on the motor vehicle.

5. The motor vehicle door lock apparatus according to claim 1, further comprising:
an auxiliary power supply configured to supply electric power to the locking and unlocking motor.

6. The motor vehicle door lock apparatus according to claim 5,
wherein the control unit is configured to
drive the locking and unlocking motor to activate the unlocking operation using electric power supplied from a battery power supply mounted on the motor vehicle, and thereafter,
when locking and unlocking detector configured to detect a state of the locking and unlocking mechanism detects a presence of a door whose locking and unlocking mechanism stays in the locking state, drive the locking and unlocking motor of at least the door to activate the unlocking operation to switch the locking and unlocking mechanism of the door to the unlocking state using the electric power supplied from the auxiliary power supply.

7. The motor vehicle door lock apparatus according to claim 1, further comprising:
an auxiliary power supply configured to supply electric power to the child proof locking motor.

8. The motor vehicle door lock apparatus according to claim 7,
wherein the control unit is configured to
drive the child proof locking motor to activate the unlocking operation using electric power supplied from a battery power supply mounted on the motor vehicle, and thereafter,
when a child proof locking detector configured to detect a state of the child proof locking mechanism detects a presence of a door whose child proof locking mechanism stays in the locking state, drive the child proof locking motor of at least the door to activate the unlocking operation to switch the child proof locking mechanism of the door to the unlocking state using the electric power supplied from the auxiliary power supply.

9. The motor vehicle door lock apparatus according claim 5,
wherein the auxiliary power supply is configured to supply electric power to both the locking and unlocking motor and the child proof locking motor.

10. The motor vehicle door lock apparatus according to claim 5,
wherein the auxiliary power supply is provided for each of the doors.

11. The motor vehicle door lock apparatus according to claim 5,
wherein the auxiliary power supply is charged by the battery power supply mounted on the motor vehicle during a period while a starter switch is on.
